(19) United States
(12) Patent Application Publication
(10) Pub. No.: US 2026/0359458 A1
(43) Pub. Date: Nov. 12, 2026

(54) PREVENTING DATA EXPOSURE DURING RETRIEVAL AUGMENTED GENERATION

(71) Applicant: INTERNATIONAL BUSINESS MACHINES CORPORATION, ARMONK, NY (US)

(72) Inventors: ACHILLE BELLY FOKOUE-NKOUTCHE, WHITE PLAINS, NY (US); SRIDEEPIKA JAYARAMAN, NEW YORK, NY (US); ELHAM KHABIRI, BRIARCLIFF MANOR, NY (US); JEFFREY OWEN KEPHART, CORTLANDT MANOR, NY (US); YINGJIE LI, CHAPPAQUA, NY (US); DHRUV SHAH, NEW YORK, NY (US); YOUSSEF DRISSI, PEEKSKILL, NY (US); FENNO F. HEATH, III, WOODBRIDGE, CT (US); ANURADHA BHAMIDIPATY, YORKTOWN HEIGHTS, NY (US); FATEH A. TIPU, WAPPINGERS FALLS, NY (US)

(21) Appl. No.: 19/203,268

(22) Filed: May 9, 2025

(51) Int. Cl. G06F 21/60; G06F 16/2455

(52) U.S. Cl. CPC G06F 21/604; G06F 16/2455

(57) ABSTRACT

Preventing data exposure during retrieval augmented generation, including: receiving, from a generative artificial intelligence (AI) model and based on a first input to the generative AI model comprising a request, an intermediate query for one or more tables, wherein the intermediate query is generated by the generative AI model as an intermediate step of a chain-of-thought for responding to the request; providing, to the generative AI model, a second input comprising a schema structure for an output of the intermediate query and an alias for the output of the intermediate query; receiving, from the generative AI model and based on the second input, a final query responsive to the request; and generating a response to the request by executing the final query.

### BACKGROUND

The present disclosure relates to methods, apparatus, and products for preventing data exposure during retrieval augmented generation.

### SUMMARY

According to embodiments of the present disclosure, various methods, apparatus and products for preventing data exposure during retrieval augmented generation are described herein. In some aspects, preventing data exposure during retrieval augmented generation includes: receiving, from a generative artificial intelligence (AI) model and based on a first input to the generative AI model comprising a request, an intermediate query for one or more tables, wherein the intermediate query is generated by the generative AI model as an intermediate step of a chain-of-thought for responding to the request; providing, to the generative AI model, a second input comprising a schema structure for an output of the intermediate query and an alias for the output of the intermediate query; receiving, from the generative AI model and based on the second input, a final query responsive to the request; and generating a response to the request by executing the final query. In some aspects, a computer system may include a processor set; one or more computer-readable storage media; and program instructions stored on the one or more storage media to cause the processor set to perform operations comprising this method. In some aspects, a computer program product may include: one or more computer readable storage media; and program instructions stored on the one or more storage media to perform operations comprising this method.

### BRIEF DESCRIPTION OF THE DRAWINGS

FIG. 1 sets forth a diagram of an example computing environment for preventing data exposure during retrieval augmented generation in accordance with some embodiments of the present disclosure.

FIG. 2 sets forth a diagram of an example system for preventing data exposure during retrieval augmented generation in accordance with some embodiments of the present disclosure.

FIG. 3 sets forth a flowchart of an example method for preventing data exposure during retrieval augmented generation in accordance with some embodiments of the present disclosure.

FIG. 4 sets forth a flowchart of another example method for preventing data exposure during retrieval augmented generation in accordance with some embodiments of the present disclosure.

FIG. 5 sets forth a flowchart of another example method for preventing data exposure during retrieval augmented generation in accordance with some embodiments of the present disclosure.

FIG. 6 sets forth a flowchart of another example method for preventing data exposure during retrieval augmented generation in accordance with some embodiments of the present disclosure.

FIG. 7 sets forth a flowchart of another example method for preventing data exposure during retrieval augmented generation in accordance with some embodiments of the present disclosure.

FIG. 8 sets forth a flowchart of another example method for preventing data exposure during retrieval augmented generation in accordance with some embodiments of the present disclosure.

### DETAILED DESCRIPTION

Retrieval augmented generation (RAG) enhances the knowledge and capabilities of generative artificial intelligence (AI) models by giving these models access to external knowledge beyond what was used to train the model. Typically, RAG includes identifying and accessing information that might be relevant to a request, such as a prompt, issued to the model. The accessed information is then provided to the model as an additional input for processing the request.

Due to the significant amount of computational resources required to deploy and execute generative AI models, systems using generative AI models may rely on third-party providers that expose their models for use. This necessarily exposes the supplemental data provided to the model to the third-party provider. Moreover, where the supplemental data is stored behind an organizational firewall this data may traverse an external network to the third-party provider, potentially exposing the data to malicious actors.

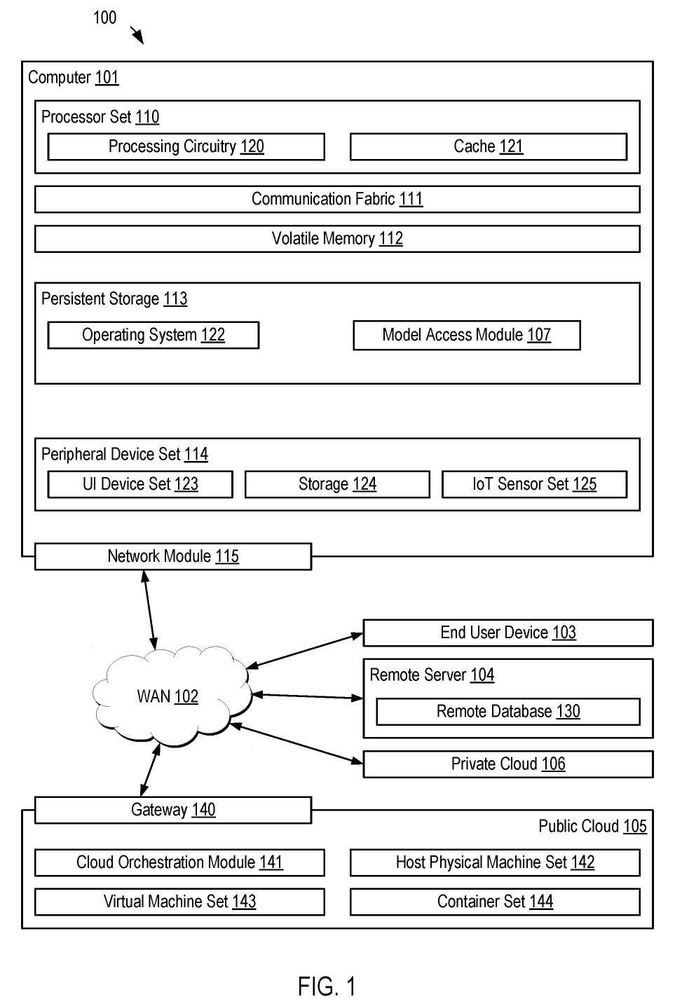

With reference now to FIG. 1, shown is a diagram of an example computing environment according to aspects of the present disclosure. Computing environment 100 contains an example of an environment for the execution of at least some of the computer code involved in performing the various methods described herein, such as the model access module 107. In addition to the model access module 107, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and the model access module 107, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document. These computer readable program instructions are stored in various types of computer readable storage media, such as cache 121 and the other storage media discussed below. The program instructions, and associated data, are accessed by processor set 110 to control and direct performance of the computer-implemented methods. In computing environment 100, at least some of the instructions for performing the computer-implemented methods may be stored in the model access module 107 in persistent storage 113.

Communication fabric 111 is the signal conduction path that allows the various components of computer 101 to communicate with each other. Typically, this fabric is made of switches and electrically conductive paths, such as the switches and electrically conductive paths that make up buses, bridges, physical input / output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in the model access module 107 typically includes at least some of the computer code involved in performing the computer-implemented methods described herein.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database), this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the computer-implemented methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

Cloud computing services and/or microservices (not separately shown in FIG. 1): private and public clouds 106 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider’s systems, and back. In some embodiments, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

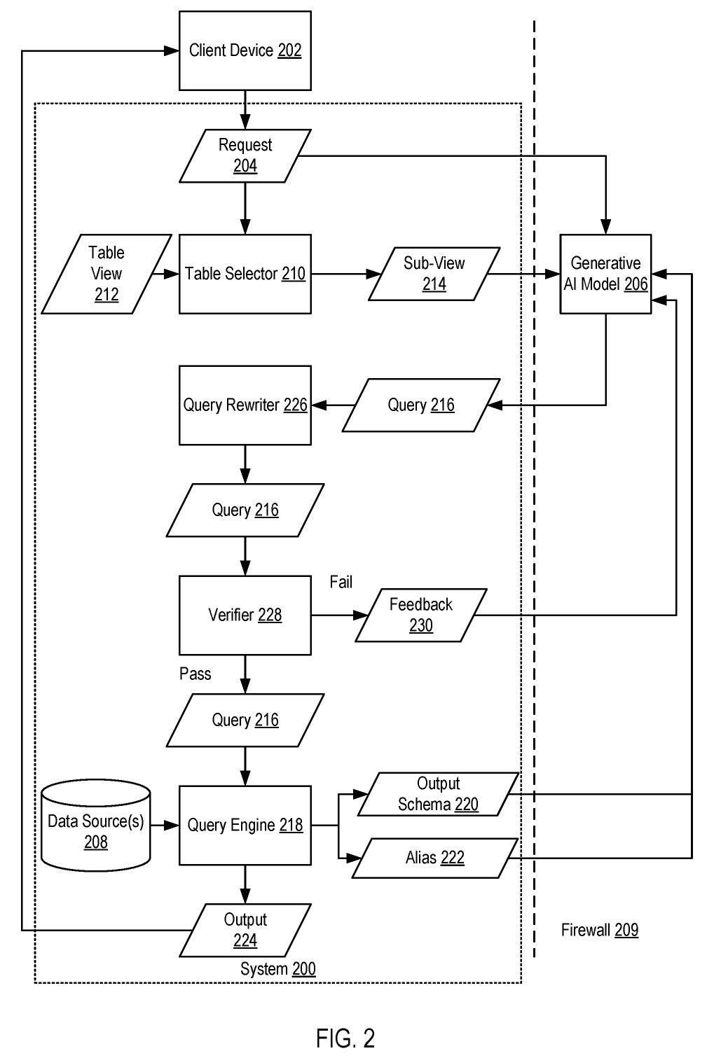

Next, FIG. 2 sets forth a diagram of an example system 200 for preventing data exposure during retrieval augmented generation in accordance with some embodiments of the present disclosure. The example system 200 may be implemented using a variety of computing devices or execution environments as can be appreciated. For example, in some embodiments, the example system 200 may be implemented using on-premises computing devices, as a cloud-based computing system 200, or combinations thereof.

In the system 200 of FIG. 2, a client device 202 issues a request 204 to be processed using a generative artificial intelligence (AI) model 206. As referred to herein, generative AI uses models such as neural networks, including large language models (LLMs), multimodal large language models (MLMMs), and the like to generate content, such as text, code, graphics, animations, video, audiovisual representations, audio, speech, etc., in response to prompts. The generative AI models are trained using a corpus of training data content to learn the patterns and structure of that content. The generative AI model may then generate new content having the characteristics learned from the training data. Prompts may include text, code, audio, graphic, video, and representations in any other media. Such prompts may be provided to the generative AI model as a natural language input. For example, the approaches set forth herein may interact with a generative AI model using predefined prompts, dynamically generated prompts, prompts that include some portion of dynamically generated content (e.g., through the use of templates and dynamically populated variables), and the like. Accordingly, the generative AI model 206 includes a model trained to perform generative AI functions as set forth above.

The request 204 includes an input or a portion of an input to be processed by the generative AI model 206. For example, in some embodiments, the input may include a prompt or another natural language expression that causes the generative AI model 206 to generate some content as described or requested by the request 204. As shown, the request 204 is issued (e.g., provided by) a client device 202. The client device 202 may include a computing device or virtual computing device, such as a computing device accessed by a user, that is communicatively coupled with the system 200 so as to provide requests 204 to the system 200 for processing. In some embodiments, the request 204 may be received via an exposed interface of the system 200. For example, in some embodiments, the request 204 may be received as an application program interface (API) call exposed to an application, process, or service used by the client device 202. Although the request 204 is shown as being received from a client device 202, readers will appreciate that the approaches set forth herein may be applied to requests 204 received from any source. For example, in some embodiments, the request 204 may be automatically or dynamically generated by a process or service executed within the system 200 itself or another computing system as can be appreciated.

The generative AI model 206 is configured to perform retrieval augmented generation (RAG) to process requests 204. Using RAG, the generative AI model 206 or an agent or service accessible to the generative AI model 206 may access data from external data sources 208 to assist processing requests 204. As referred to herein, an external data source 208 is a knowledge base or other source of information other than the knowledge base upon which the generative AI model 206 was trained or fine-tuned. For example, these external data sources 208 may include tables in databases or data warehouses, APIs, and the like. In some embodiments, one or more of these data sources 208 may be located within the system 200 or remotely disposed from the system 200. Particularly, in some embodiments, one or more of these data sources 208 may be behind a firewall 209 separating the system 200 from the generative AI model 206.

In some embodiments, the generative AI model 206 may be supported or deployed by an organization separate from the organization implementing the system 200. For example, in some embodiments, the generative AI model 206 may be supported or deployed by a third-party provider of generative AI model 206. In some existing implementations, the generative AI model 206 may use RAG by directly accessing or having data provided from these data sources 208, including data sources on the other side of the firewall 209. These implementations may pose certain security or privacy risks in relation to the data used by the generative AI model 206 for RAG. For example, these implementations may require that this data traverse the firewall 209 using an external network, potentially exposing this data to being compromised by a malicious actor. As another example, these implementations require that the data be provided to and processed by a generative AI model 206 outside of the control of the organization of the system 200, potentially exposing this data to unknown actors.

To address these concerns, rather than allowing the generative AI model 206 to access this data directly, the request 204 is first provided to a table selector 210. The table selector 210 determines which data sources 208 (e.g., which tables, APIs, and the like) may be useful or usable by the generative AI model 206 to process the request 204. In some embodiments, the table selector 210 may include a trained machine learning model. For example, in some embodiments, the table selector 210 may include a language model trained to interpret natural language inputs such as an LLM. In this example, the table selector 210 may include an off-the-shelf or other model that has not been specifically trained to determine data sources 208 for processing requests 204. In some embodiments, the table selector 210 may include a smaller model such as a small language model (SLM) that has been trained or fine-tuned to perform these functions. In some embodiments, the table selector 210 may be implemented using other approaches.

In addition to the request 204 the table selector 210 accepts, as input, a table view 212. A table view 212 is data describing relationships between the different data sources 208. Particularly, in some embodiments, the table view 212 describes the relationships between different tables by identifying which columns of certain tables are related to or included in other tables. For example, in some embodiments, the table view 212 may describe foreign key or other relationships between tables. In some embodiments, the table view 212 may be encoded as an Entity-Relationship Diagram. In some embodiments, the table view 212 may be encoded as a graph whereby each table is encoded as a node and each relationship is encoded as an edge in the graph. In some embodiments, the table view 212 may be manually coded or at least partially manually coded. In some embodiments, the table view 212 may be automatically or at least partially automatically generated based on table metadata, API metadata, or other data as can be appreciated.

As is set forth above, in some embodiments, the data sources 208 may include tables and/or APIs. An API is considered a data source 208 in that the data returned in response to a particular API call may be considered a data source 208. In order for APIs to be represented in the table view 212, in some embodiments, each API (e.g., each API call to be used as a data source 208) may be converted into a virtual table. A virtual table is a logical representation of a table (e.g., a database table) without necessarily creating or encoding the table itself for storing records. For example, in some embodiments, the data returned in response to a given API call may adhere to some schema, including one or more fields and one or more values for those fields. Accordingly, in some embodiments, this API call may be converted into a virtual table having columns corresponding to the fields of the API call response. In some embodiments, this may include accessing API metadata such as an API mapping schema describing the necessary information to invoke an API call such as a Uniform Resource Locator (URL) for issuing Api calls, a method used for using API calls (e.g., POST, GET), and/or details of the input and output parameters for the API call. This virtual table schema may then be included in the table view 212, thereby including the APIs in the table view 212. In other words, the schema of the API response is converted into a virtual table schema that enables APIs to be represented in the table view 212 as virtual tables. This allows the table view 212 to describe relationships between pairs of tables, between pairs of APIs, and/or between a table and an API. In other words, the table view 212 provides an abstract schema or view describing the relationships between different data sources 208 agnostic as to whether those data sources 208 are tables or APIs.

The table selector 210 then selects, from the table view 212, one or more of the data sources 208 described by the table view 212 that may be useful in processing the request 204, shown as a sub-view 214. In some embodiments, this sub-view 214 may include one or more subgraphs of a graph or ER diagram encoding of the table view 212. For example, assume that the request 204 includes the natural language expression “Show high priority alarms from February 22, 2021, involving tags from the same cascade as 3CNF01.” By processing this natural language expression, the table selector 210 may select, as a sub-view 214, an “alarm” table, a “tag” table, and a “cascade” table. In this example, the cascade table may include a virtual table corresponding to an API call for accessing cascade information. Moreover, both the alarm and cascade tables may each include fields for “tags” that have a foreign key relationship with the tags table. Accordingly, the selected sub-view 214 may include a subgraph linking nodes corresponding to these tables.

Next, rather than allowing the generative AI model 206 to query these tables directly for their stored information, the table selector 210 provides the sub-view 214 to the generative AI model 206. The sub-view 214 as provided to the generative AI model 206 indicates the schema (e.g., the columns) of the tables represented in the sub-view 214 and any relationships between those tables. The request 204 is also provided to the generative AI model 206 for processing based on the sub-view. For example, in some embodiments, the request 204 and the sub-view may be provided as separate inputs to the generative AI model 206 or as part of the same input or prompt to the generative AI model 206.

A prompt to the generative AI model 206 (e.g., including the request or issued prior to the generative AI model 206) may instruct the generative AI model 206 to process the request 204 using a chain-of-thought. Using a chain-of-thought, rather than attempt to fully process the request 204 to generate some output, the generative AI model 206 may process the request 204 in a step-by-step fashion, outputting the rationale behind each step. Particularly, in some embodiments, the prompt may instruct the generative AI model 206 to provide, for each step of the chain-of-thought, an intermediary output. In some embodiments, this may include the rationale for that step. In some embodiments, this intermediary output may include a query 216 that should be executed to perform that step. Such a query 216 may include, for example, a database statement encoded in Structured Query Language (SQL) or some other query language as can be appreciated. As this query 216 was generated by the generative AI model 206 as part of an intermediate step of the chain-of-thought, this query 216 is hereinafter referred to as an intermediate query 216.

Rather than execute this intermediate query 216 to provide the generative AI model 206 with the returned data, the intermediate query 216 is executed a query engine 218 of the system 200. The query engine 218 is a set of hardware and/or software resources for processing and executing queries 216, such as a database system. As shown, queries 216 including the intermediate query 216 may be subject to additional processing or transformation before being executed by the query engine 218, which will be described in further detail below. After executing the intermediate query 216, assuming the intermediate query 216 successfully executed, an output schema 220 and an alias 222 are returned back to the generative AI model 206 in response to the intermediate query 216. The output schema 220 is the schema of the data returned in response to executing the intermediate query 216, such as column names, column data types, and the like.

The alias 222 is the name of a temporary table into which output for the intermediate query 216 can be stored. This alias 222 is usable by the generative AI model 206 in subsequent iterations of the chain-of-thought for processing the request 204. In other words, the alias 222 serves as a reference data point for further processing the request 204 using any data that would be returned in response to the intermediate query 216.

In some embodiments, a description or rationale generated by the generative AI model 206 for this step of the chain-of-thought may be provided to the client device 202. In some embodiments, a description of the intermediate query 216, the output schema 220, the alias 222, or other information may also be provided to the client device 202. In some embodiments, the client device 202 renders or presents this information to a user, informing the user as to the chain-of-thought of the generative AI model 206 in processing their request 204.

This process of, for each step of the chain-of-thought, receiving intermediate queries 216, verifying that the intermediate query 216 successfully executes, and providing the output schema 220 and alias 222 to the generative AI model 206 until the generative AI model 206 completes the final step of the chain-of-thought, outputting a query 216 that, when executed, accesses data from the data sources 208 to be used in the response to the request 204. As this query 216 is generated as part of the final step of the chain-of-thought it is hereinafter referred to as a final query 216. The query engine 218 then executes the final query 216 to produce some output 224. In some embodiments, this output 224 may be returned (e.g., to the client device 202) in response to the request 204. In some embodiments, this output 224 may be transformed, combined with other data, or otherwise used to generate a response returned in response to the request 204. Thus, data from the data sources 208 are never exposed to the generative AI model 206 when processing the request 204.

As is set forth above, in some embodiments, a query 216 (e.g., intermediate and/or final) may be subject to additional transformations or processing before being provided to the query engine 218 for execution. In some embodiments, APIs included in the data sources 208 are represented in the table view 212 by virtual tables. In some embodiments, a query 216 from the generative AI model 206 may be directed to one of these virtual tables as the generative AI model 206 has no knowledge whether a table in the table view 212 is a real or virtual table. Accordingly, absent any modification, queries 216 attempting to access a virtual table corresponding to an API will fail as that virtual table is not queryable. In some embodiments, a query rewriter 226 replaces references to virtual tables with functions that, when executed by the query engine 218, invokes the corresponding API. For example, in some embodiments, a User-Defined Function (UDFs) may be defined for each API data source 208 that, when executed, invokes the corresponding API. Thus, when the query 216 is executed, the added UDF is executed so as to access data using the corresponding API. In some embodiments, these replaced references may include the virtual table name and/or a database statement or clause including that virtual table name. For example, where a query 216 includes a SELECT statement directed to a virtual table for selecting records satisfying certain filters, that SELECT statement may be replaced with a UDF calling the corresponding API and using the values for those filters as parameters for the UDF and, in turn, the API call.

In some embodiments, the system 200 may implement various guardrails or protections to ensure that a query 216 is encoded or structured correctly before execution. Accordingly, in some embodiments, a verifier 228 enforces these guardrails or protections with respect to input queries 216. The verifier 228 is a process, service, or application for verifying queries 216 provided as input. The verifier 228 may verify a query 216 using various approaches or rules. For example, in some embodiments, the verifier 228 determines whether all entity names and properties in a query 216 are valid, whether all API signatures and parameters are valid, whether referenced column names are included in the schema of the corresponding table, and the like. Readers will appreciate that other approaches may also be used by the verifier 228 in verifying queries 216 before execution.

In some embodiments, if a query 216 passes verification the verifier 228 forwards the query 216 for subsequent processing, including execution by the query engine 218. In some embodiments, if a query 216 fails verification, the verifier 228 may attempt to fix or remediate the query 216 by correcting any errors, if possible, so as to cause the query 216 to pass verification. In some embodiments, if a query 216 fails verification and/or if that query 216 cannot be fixed, the verifier 228 may provide feedback 230 to the generative AI model 206 indicating that the query 216 failed verification. In some embodiments, this feedback 230 may include an indication or description of why the query 216 failed verification. In some embodiments, this feedback 230 causes the generative AI model 206 to regenerate the failed query 216, taking into account the feedback 230 so as to guide the generative AI model 206 in producing queries 216 that will pass verification.

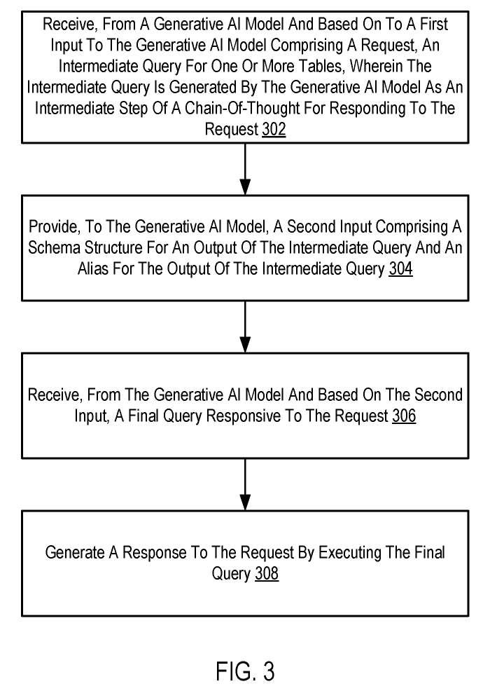

For further explanation, FIG. 3 sets forth a flowchart of another example method of preventing data exposure during retrieval augmented generation in accordance with some embodiments of the present disclosure. The method of FIG. 3 may be performed, for example, by the model access module 107 of FIG. 1 and/or the system 200 of FIG. 2. The method of FIG. 3 includes receiving 302, from a generative artificial AI model 206 and based on a first input to the generative AI model 206 comprising a request 204, an intermediate query 216 for one or more tables, wherein the intermediate query 216 is generated by the generative AI model 206 as an intermediate step of a chain-of-thought for responding to the request 204. In some embodiments, the intermediate query 216 is received in response to a prompt (e.g., including the request 204) indicating that the generative AI model 206 should process the request 204 using a chain-of-thought process whereby, after each step of the chain-of-thought, the generative AI model 206 outputs a query 216 corresponding to or based on this step. Here, the query 216 is an intermediate query 216 as it was generated by the generative AI model 206 as part of an intermediary (e.g., non-final) step of the chain-of-thought for processing the request 204.

The method of FIG. 3 also includes providing 304, to the generative AI model 206, a second input comprising a schema structure for an output of the intermediate query 216 (e.g., an output schema 220) and an alias 222 for the output of the intermediate query 216. In some embodiments, after receiving 302 the intermediate query 216, the intermediate query 216 is executed (e.g., by a query engine 218). In some embodiments, in response to the intermediate query 216 successfully executing, the output schema 220 and alias 222 are provided back to the generative AI model 206 for use in performing the next step of the chain-of-thought for processing the request 204. This allows the generative AI model 206 to continue processing the request 204 based on the output schema 220 of the intermediate query 216 and without exposing the data that is returned in response to the intermediate query 216 to the generative AI model 206. In some embodiments, the steps of receiving 302 an intermediate query and providing 304 the output schema 220 and alias 222 to the generative AI model 206 are repeatedly performed for multiple intermediate steps of the chain-of-thought.

The method of FIG. 3 also includes receiving 306, from the generative AI model 206, a final query 216 responsive to the request 204. The final query 216 is “final” in that it was generated or provided as output for a final step of the chain-of-thought for processing the request 204. This final query 216 is based on the second input in that it takes into consideration any previously received second inputs for any previously performed intermediate steps of the chain-of-thought for processing the request 204.

The method of FIG. 3 also includes generating 308 a response to the request 204 by executing the final query 216. In some embodiments, the final query 216 is executed (e.g., by the query engine 218) to generate an output 224 responsive to the final query 216. In some embodiments, this output 224 is included in a response to the request 204. In some embodiments, this output 224 is further transformed or processed for inclusion in the response to the request 204. The response is then returned to a source of the request 204, such as a client device 202 or some process or service that generated the request 204.

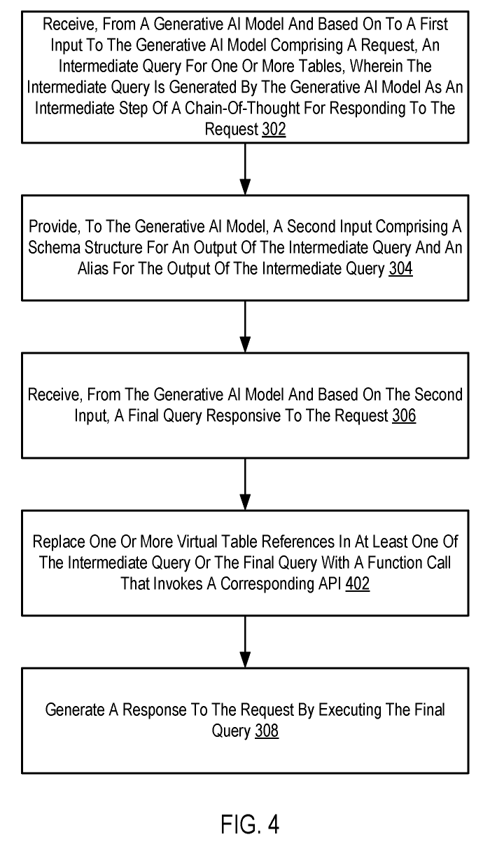

For further explanation, FIG. 4 sets forth a flowchart of another example method of preventing data exposure during retrieval augmented generation in accordance with some embodiments of the present disclosure. The method of FIG. 4 is similar to FIG. 3 in that the method of FIG. 4 also includes: receiving 302, from a generative artificial AI model 206 and based on a first input to the generative AI model 206 comprising a request 204, an intermediate query 216 for one or more tables, wherein the intermediate query 216 is generated by the generative AI model 206 as an intermediate step of a chain-of-thought for responding to the request 204; providing 304, to the generative AI model 206, a second input comprising a schema structure for an output of the intermediate query 216 and an alias 222 for the output of the intermediate query 216; receiving 306, from the generative AI model 206, a final query 216 responsive to the request 204; and generating 308 a response to the request 204 by executing the final query 216.

The method of FIG. 4 differs from FIG. 3 in that the method of FIG. 4 also includes replacing 402 one or more virtual table references in at least one of the intermediate query 216 or the final query 216 with a function call that invokes a corresponding API. Readers will appreciate that, although replacing 402 the one or more virtual table references is shown as being performed after receiving 306 the final query, this is merely illustrative and that replacing 402 the one or more virtual table references may be performed any time after receiving and before executing any intermediate or final query 216.

In some embodiments, the generative AI model 206 generates queries 216 based on information describing relationships between tables. These tables may include actual queryable tables or virtual tables corresponding to APIs. Accordingly, queries 216 needing to access data via an API will include a reference to the virtual table corresponding to that API. These references will cause the query 216 to fail execution as these virtual tables do not actually exist. Accordingly, in some embodiments, a query rewriter 226 replaces these references with functions that, when executed, invoke the API corresponding to the virtual table. For example, in some embodiments, a reference to a virtual table may be replaced with a UDF call that, when executed, invokes the corresponding API. Thus, after replacing these virtual table references, the query 216 will not fail execution due to including a reference to an invalid table.

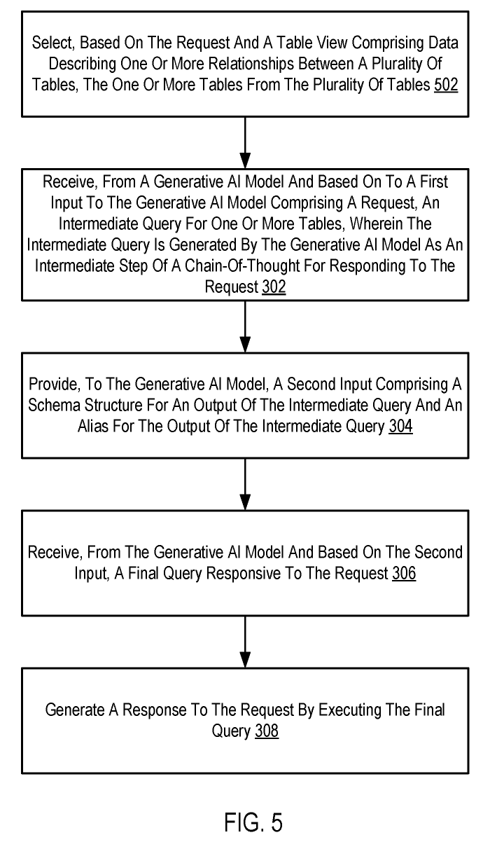

For further explanation, FIG. 5 sets forth a flowchart of another example method of preventing data exposure during retrieval augmented generation in accordance with some embodiments of the present disclosure. The method of FIG. 5 is similar to FIG. 3 in that the method of FIG. 5 also includes: receiving 302, from a generative artificial AI model 206 and based on a first input to the generative AI model 206 comprising a request 204, an intermediate query 216 for one or more tables, wherein the intermediate query 216 is generated by the generative AI model 206 as an intermediate step of a chain-of-thought for responding to the request 204; providing 304, to the generative AI model 206, a second input comprising a schema structure for an output of the intermediate query 216 and an alias 222 for the output of the intermediate query 216; receiving 306, from the generative AI model 206, a final query 216 responsive to the request 204; and generating 308 a response to the request 204 by executing the final query 216.

The method of FIG. 5 differs from FIG. 3 in that the method of FIG. 5 also includes selecting 502, based on the request 204 and a table view 212 comprising data describing one or more relationships between a plurality of tables, the one or more tables from the plurality of tables. In some embodiments, the plurality of tables may include queryable tables and/or virtual tables corresponding to APIs. In some embodiments, the table view 212 may describe relationships between these tables by indicating particular columns or fields from one table that are included in another table. For example, in some embodiments, the table view 212 may describe foreign key or other relationships between tables. In some embodiments, the table view 212 may be encoded as an Entity-Relationship Diagram. In some embodiments, the table view 212 may be encoded as a graph whereby each table is encoded as a node and each relationship is encoded as an edge in the graph. In some embodiments, the table view 212 may be manually coded or at least partially manually coded. In some embodiments, the table view 212 may be automatically or at least partially automatically generated based on table metadata, API metadata, or other data as can be appreciated.

The one or more tables are selected 502 from the plurality of tables by processing or interpreting the request 204 to identify, based on the table view 212, the one or more tables as being useful or relevant to the request 204. In other words, in some embodiments, the one or more tables are selected 502 from the plurality of tables by identifying the one or more tables as storing, or representing, in the case of virtual tables, data usable in processing the request 204. For example, in some embodiments, a table selector 210 may be implemented as a language model or other machine learning model that accepts, as input, the request 204 and the table view 212 and provides, as output, a sub-view 214 indicating the one or more tables and their relationships to each other.

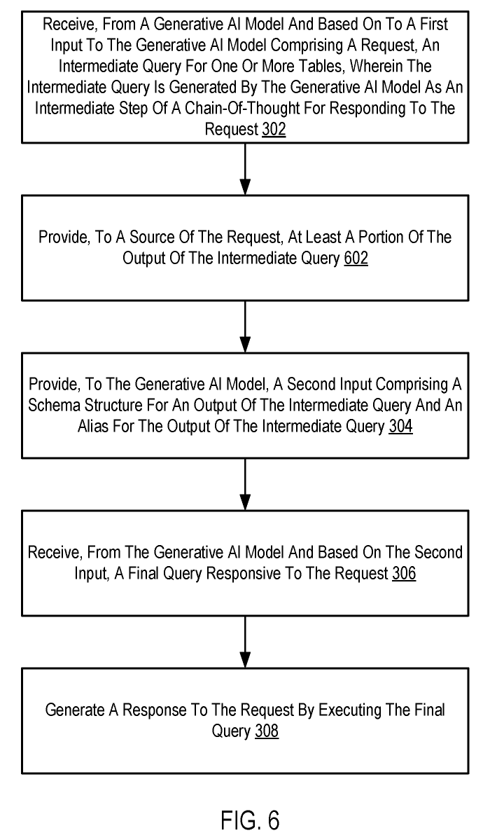

For further explanation, FIG. 6 sets forth a flowchart of another example method of preventing data exposure during retrieval augmented generation in accordance with some embodiments of the present disclosure. The method of FIG. 6 is similar to FIG. 3 in that the method of FIG. 6 also includes: receiving 302, from a generative artificial AI model 206 and based on a first input to the generative AI model 206 comprising a request 204, an intermediate query 216 for one or more tables, wherein the intermediate query 216 is generated by the generative AI model 206 as an intermediate step of a chain-of-thought for responding to the request 204; providing 304, to the generative AI model 206, a second input comprising a schema structure for an output of the intermediate query 216 and an alias 222 for the output of the intermediate query 216; receiving 306, from the generative AI model 206, a final query 216 responsive to the request 204; and generating 308 a response to the request 204 by executing the final query 216.

The method of FIG. 6 differs from FIG. 3 in that the method of FIG. 6 also includes providing 602, to a source of the request 204, at least a portion of the output of the intermediate query 216. The source of the request 204 may include, for example, a client device 202, a process, application, or service executed within a system 200, and the like. The output of the intermediate query 216 includes data returned in response to executing the intermediate query 216 and/or other data associated with executing the intermediate query 216. In some embodiments, providing 602 the at least a portion of the output causes the at least a portion of the output to be displayed or rendered by a client device 202, thereby informing a user as to the chain-of-thought of the generative AI model 206 in processing the request 204. For example, in some embodiments, the at least a portion of the output may include an output schema 220 for the output of the intermediate query 216. As another example, in some embodiments, the at least a portion of the output may include an alias 222 for the output of the intermediate query 216. In some embodiments, providing 602 the at least a portion of the output of the intermediate query 216 may also include providing the rationale generated by the generative AI model 206 for the intermediate step corresponding to the intermediate query 216.

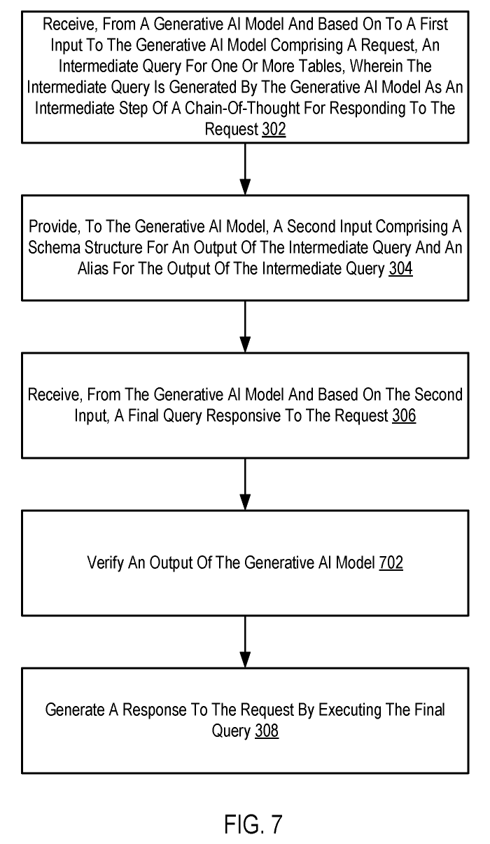

For further explanation, FIG. 7 sets forth a flowchart of another example method of preventing data exposure during retrieval augmented generation in accordance with some embodiments of the present disclosure. The method of FIG. 7 is similar to FIG. 3 in that the method of FIG. 7 also includes: receiving 302, from a generative artificial AI model 206 and based on a first input to the generative AI model 206 comprising a request 204, an intermediate query 216 for one or more tables, wherein the intermediate query 216 is generated by the generative AI model 206 as an intermediate step of a chain-of-thought for responding to the request 204; providing 304, to the generative AI model 206, a second input comprising a schema structure for an output of the intermediate query 216 and an alias 222 for the output of the intermediate query 216; receiving 306, from the generative AI model 206, a final query 216 responsive to the request 204; and generating 308 a response to the request 204 by executing the final query 216.

The method of FIG. 7 differs from FIG. 3 in that the method of FIG. 7 also includes verifying 702 an output of the generative AI model 206. Particularly, verifying 702 the output of the generative AI model 206 includes verifying a query 216 generated by the generative AI model 206, including intermediate and/or final queries 216. Readers will appreciate that, although verifying 702 an output of the generative AI model 206 is shown as being performed after receiving 306 the final query, this is merely illustrative and that verifying 702 an output of the generative AI model 206 may be performed any time after receiving and before executing any intermediate or final query 216. In some embodiments, verifying 702 the output of the generative AI model 206 include confirming that the output (e.g., the query 216) satisfies one or more conditions or rules. For example, in some embodiments, the verifying 702 the output includes determining whether all entity names and properties in a query 216 are valid, whether all API signatures and parameters are valid, whether referenced column names are included in the schema of the corresponding table, and the like. Other rules or criteria for verifying 702 queries 216 are also contemplated within the scope of the present disclosure that may be used in addition to or instead of any of the approaches set forth herein.

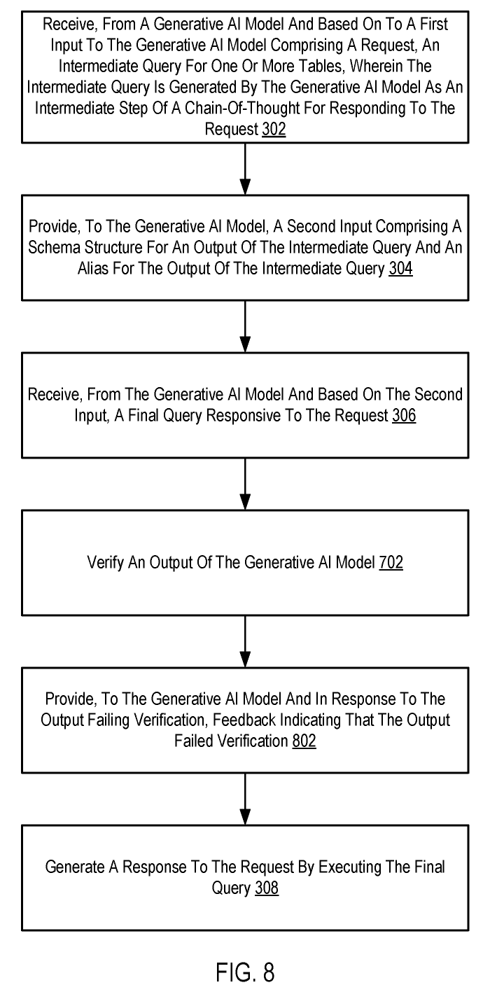

For further explanation, FIG. 8 sets forth a flowchart of another example method of preventing data exposure during retrieval augmented generation in accordance with some embodiments of the present disclosure. The method of FIG. 8is similar to FIG. 7 in that the method of FIG. 8 also includes: receiving 302, from a generative artificial AI model 206 and based on a first input to the generative AI model 206 comprising a request 204, an intermediate query 216 for one or more tables, wherein the intermediate query 216 is generated by the generative AI model 206 as an intermediate step of a chain-of-thought for responding to the request 204; providing 304, to the generative AI model 206, a second input comprising a schema structure for an output of the intermediate query 216 and an alias 222 for the output of the intermediate query 216; receiving 306, from the generative AI model 206, a final query 216 responsive to the request 204; verifying 702 an output of the generative AI model 206; and generating 308 a response to the request 204 by executing the final query 216.

The method of FIG. 8 differs from FIG. 7 in that the method of FIG. 8 also includes providing 802, to the generative AI model 206 and in response to the output failing verification, feedback 230 indicating that the output failed verification. In some embodiments, if a query 216 fails verification, a verifier 228 (e.g., a process or service performing query 216 verification) may attempt to fix or remediate the query 216 by correcting any errors, if possible, so as to cause the query 216 to pass verification. In some embodiments, if a query 216 fails verification and/or if that query 216 cannot be fixed, the verifier 228 may provide feedback 230 to the generative AI model 206 indicating that the query 216 failed verification. In some embodiments, this feedback 230 may include an indication or description of why the query 216 failed verification. In some embodiments, this feedback 230 causes the generative AI model 206 to regenerate the failed query 216, taking into account the feedback 230 so as to guide the generative AI model 206 in producing queries 216 that will pass verification.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment ("CPP embodiment" or “CPP”) is a term used in the present disclosure to describe any set of one, or more, storage media (also called "mediums") collectively included in a set of one, or more, storage devices that collectively include machine readable code corresponding to instructions and/or data for performing computer operations specified in a given CPP claim. A "storage device" is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits / lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method comprising:
receiving, from a generative artificial intelligence (AI) model and based on a first input to the generative AI model comprising a request, an intermediate query for one or more tables, wherein the intermediate query is generated by the generative AI model as an intermediate step of a chain-of-thought for responding to the request;
providing, to the generative AI model, a second input comprising a schema structure for an output of the intermediate query and an alias for the output of the intermediate query;
receiving, from the generative AI model and based on the second input, a final query responsive to the request; and
generating a response to the request by executing the final query.

2. The computer-implemented method of claim 1, wherein receiving the intermediate query from the generative AI model and providing the second input to the generative AI model are repeatedly performed for a plurality of intermediate steps of the chain-of-thought for responding to the request.

3. The computer-implemented method of claim 1, further comprising replacing one or more virtual table references in at least one of the intermediate query or the final query with a function call that invokes a corresponding application program interface (API).

4. The computer-implemented method of claim 1, wherein the first input further comprises data describing one or more relationships between the one or more tables.

5. The computer-implemented method of claim 4, further comprising selecting, based on the request and a table view comprising data describing one or more relationships between a plurality of tables, the one or more tables from the plurality of tables.

6. The computer-implemented method of claim 1, wherein providing the second input to the generative AI model is performed in response to successfully executing the intermediate query.

7. The computer-implemented method of claim 1, further comprising providing, to a source of the request, at least a portion of the output of the intermediate query.

8. The computer-implemented method of claim 1, further comprising verifying an output of the generative AI model, wherein the output comprises the intermediate query or the final query.

9. The computer-implemented method of claim 8, wherein providing, to the generative AI model and in response to the output failing verification, feedback indicating that the output failed verification, wherein the feedback causes the generative AI model to regenerate the output based on the feedback.

10. The computer-implemented method of claim 1, wherein the one or more tables comprise one or more virtual tables each corresponding to a respective API.

11. A computer system comprising:
a processor set;
one or more computer-readable storage media; and
program instructions stored on the one or more storage media to cause the processor set to perform operations comprising:
receiving, from a generative artificial intelligence (AI) model and based on a first input to the generative AI model comprising a request, an intermediate query for one or more tables, wherein the intermediate query is generated by the generative AI model as an intermediate step of a chain-of-thought for responding to the request;
providing, to the generative AI model, a second input comprising a schema structure for an output of the intermediate query and an alias for the output of the intermediate query;
receiving, from the generative AI model and based on the second input, a final query responsive to the request; and
generating a response to the request by executing the final query.

12. The computer system of claim 11, wherein receiving the intermediate query from the generative AI model and providing the second input to the generative AI model are repeatedly performed for a plurality of intermediate steps of the chain-of-thought for responding to the request.

13. The computer system of claim 11, wherein the operations further comprise replacing one or more virtual table references in the final query with a function call that invokes a corresponding application program interface (API).

14. The computer system of claim 11, wherein the first input further comprises data describing one or more relationships between the one or more tables.

15. The computer system of claim 14, wherein the operations further comprise selecting, based on the request and a table view comprising data describing one or more relationships between a plurality of tables, the one or more tables from the plurality of tables.

16. The computer system of claim 11, wherein providing the second input to the generative AI model is performed in response to successfully executing the intermediate query.

17. The computer system of claim 11, wherein the operations further comprise providing, to a source of the request, at least a portion of the output of the intermediate query.

18. The computer system of claim 11, wherein the operations further comprise verifying an output of the generative AI model, wherein the output comprises the intermediate query or the final query.

19. The computer system of claim 18, wherein providing, to the generative AI model and in response to the output failing verification, feedback indicating that the output failed verification, wherein the feedback causes the generative AI model to regenerate the output based on the feedback.

20. A computer program product comprising:
one or more computer-readable storage media; and
program instructions stored on the one or more storage media to perform operations comprising:
receiving, from a generative artificial intelligence (AI) model and based on a first input to the generative AI model comprising a request, an intermediate query for one or more tables, wherein the intermediate query is generated by the generative AI model as an intermediate step of a chain-of-thought for responding to the request;
providing, to the generative AI model, a second input comprising a schema structure for an output of the intermediate query and an alias for the output of the intermediate query;
receiving, from the generative AI model and based on the second input, a final query responsive to the request; and
generating a response to the request by executing the final query.
